(19) United States
(12) Patent Application Publication
(10) Pub. No.: US 2003/0105830 A1
(43) Pub. Date: Jun. 5, 2003

(54) Scalable network media access controller and methods

(76) Inventors: Duc Pham, Cupertino, CA (US); Nam Pham, San Jose, CA (US); Pu Paul Zhang, San Jose, CA (US); Tien Le Nguyen, Cupertino, CA (US)

Correspondence Address: GERALD B ROSENBERG, NEW TECH LAW, 285 HAMILTON AVE, SUITE 520, PALO ALTO, CA, 94301, US

(21) Appl. No.: 10/020,554

(22) Filed: Dec. 3, 2001

(51) Int. Cl. G06F 15/167

(52) U.S. Cl. 709/216; 709/229; 709/239

(57) ABSTRACT

A secure storage access controller provides for the proxy routing of data transfer requests and responses between network clients and storage servers. The controller includes first and second network interface processors coupleable to client and data storage networks and a plurality of data packet processors coupled to the first and second network interface processors. Each data packet processor is operative to terminate respective client network connections routed to the plurality of data packet processors through the first network interface processor and to establish respective storage network connections through the second network interface processor. The data packet processors provide for the proxy transport of data transfer requests and responses between the client and storage network connections. Each the data packet processor includes an encryption engine operative to selectively encrypt media-level data contained within data transfer requests and responses as transported from the client network connections to the storage network connections.

### CROSS-REFERENCE TO RELATED APPLICATIONS

The present application is related to the following Applications, assigned to the Assignee of the present Application:

NETWORK MEDIA ACCESS ARCHITECTURE AND METHODS FOR SECURE STORAGE, by Pham et al. and assigned to the Assignee of the present Application.

### BACKGROUND OF THE INVENTION

1. Field of the Invention

The present invention is generally related to providing data security for distributed data storage systems and, in particular, to an architecture and methods of providing comprehensive security for network attached storage systems.

2. Description of the Related Art

The need and value of distributed data storage, particularly in connection with the access and protection of enterprise data, are becoming widely accepted. Distributed data storage can be flexibly architected to enable global access to data, live-data redundancy, often involving geographically distributed live-data stores, and remote backup, including hot-backup, of critical data. Even in application to the basic need for off-line mass data-store backups, the value of using a remote network-attached storage system is evident over the tedious performance of periodic, on-site data dumps with manual shipment of physical backup media to remote storage. Thus, depending on the particular priorities of an enterprise, different configurations of network-attached storage can be used to implement a beneficial distributed data storage system.

The easy implementation of dedicated storage area network (SAN) intranets and the broad availability of the public Internet infrastructure has greatly facilitated the broad use of network attached storage. A shared SAN is often used to centralize the management and maintenance of storage resources within organizations of various sizes. Third-party storage service providers (SSPs) are also available to provide remote SAN hosting.

A variety of network capable devices, from conventional network server systems to dedicated storage appliances, are available as the architectural building blocks of network-attached storage systems. Many of these devices implement support for the iSCSI protocol (IETF Internet Draft draft-ietf-ips-iSCSI-08. txt; www.ietf.org) to obtain reliable storage data transport over a conventional TCP/IP network. The iSCSI protocol itself encapsulates an I/O storage command and data structure that conforms to the small computer system interface (SCSI) architecture model (SAM2). Whereas SAM2 defines a local, direct attach client-server data transport protocol, the iSCSI protocol encapsulation of SAM2 adds global network naming support for initiator-target communication between network connected data source (initiator) and terminal storage (target) devices. The iSCSI protocol thus combines the benefits of IP remote transport and the reliable quality of service (QoS) provided by the TCP protocol with storage transaction session control under the SCSI protocol. Various similar protocols exist, such as Fibre Channel Over TCP/IP (FCIP; IETF Internet Draft draft-ietf-ips-fcovertcpip-06.txt) to define storage transport over particular network media and using other storage architecture models.

There are, however, a number of practical and architectural problems inherent in conventional distributed data storage systems. Data security and control over the security management function are typically recognized as the most significant problems. The data security problem involves issues of transport security, access security, and storage security. Transport security concerns ensuring that data is delivered between an initiator and target without eavesdropping. The iSCSI protocol anticipates the complementary use of conventional transport security protocols, such as IPsec (Security Architecture for the Internet Protocol; RFC 2401; www.ietf.org), to provide secure encryption for data in transport. The IPsec supported encryption, however, covers only the transport phase with the result of providing clear text data at the transport end.

Both the iSCSI and the IPsec protocols can handle at least some access security issues through host authentication. IPsec and iSCSI perform initial host authentication transactions based on either a public key signature exchange or preshared keys. Under IPsec, host authentication provides assurance that session level access is between verified and thus jointly known initiator and target systems. Under iSCSI, the optional authentication negotiation can extend to the application level to provide secure access down to a named iSCSI target. Host authentication is established under the iSCSI protocol through the iSCSI login command exchanges and maintained through the utilization of a digital digest exchanged with the iSCSI packets between the initiator and target devices.

U.S. Pat. No. 6,263,445 provides an alternative and proprietary methodology for providing host authentication. Like the IPsec protocol, host authentication is initially negotiated between a host system and network storage system based on a public key exchange to verify identities. The '445 patent, however, contemplates network data transfers based only on the IP protocol. To add features of protocol reliability and host authentication, conventionally provided by use of the TCP protocol, each host data request and response exchanged throughout a data-transfer session are marked with sequence numbers based on a preestablished ordering algorithm.

The IPsec, iSCSI, and proprietary protocols such as the one presented by the '445 patent do not address storage security. Conventionally, data as delivered to a destination site for storage is protected there only by the security practices of the destination site. Typically, destination security is implemented by physical site security and locally administered encryption of the data. Such security practices, while potentially adequate, are neither guaranteed nor nominally within the control of the source data owner.

Where stored data represents a substantial financial or operational value, a destination site security breach is often considered an unacceptable risk by the source data owner. In such cases, conventional client-based encryption systems are often used. Client encryption, either application or filesystem based, ensures that client data is encrypted local to the client prior to network transport. Thus, clear text client data can only be recovered by a client with access to a corresponding encryption key, which is entirely controlled by the source data owner. U.S. Pat. No. 5,931,947 describes such a filesystem-based encryption system, where files are stored remotely as encrypted data objects. An encrypted object is created on the client filesystem whenever a file is stored to the distributed filesystem. The encryption is based on per-client allocated security keys, thereby ensuring that encrypted content can only be accessed from the original encrypting client. Consequently, any failure of destination site security over stored data does not compromise the security of the underlying data. The data can be physically lost, but not, as a practical matter, accessed due to the client encryption of the data. The client can protect against physically lost data by mirroring storage or otherwise keeping redundant copies.

While the different aspects of data security can be addressed at least by some degree by selective use of protocols and client-based encryption, the provided solutions create additional security management problems. Management of access rights and privileges to different encryption keys is necessary to maintain the integrity of data in shared storage and ensure the security and privacy of the data. Such management and control requirements, which must extend over many different clients with many different data access requirements relative to potentially multiple distributed storage systems, represents a very complex and management intensive task.

The IPsec and iSCSI protocols, as formally defined, provide no significant practical support for access management control to storage targets or specific resources within the targets. Other protocols, such as that described in the '445 patent, and network storage server operating systems implement various systems of access request filtering on the storage server. Each received request is examined by the storage server against a persistent access rights table that is local to the storage server. The integrity of the access rights table is therefore subject to the limitations of the destination site security. The access rights table is therefore outside of the assured control of the data content owner, particularly where the distributed storage system is remotely hosted and managed by a third-party SSP.

Similarly, application and filesystem-based storage security is highly problematic to manage. Client-based encryption systems are, by their nature, distributed. There is no centralized key management system except as may be implemented manually, which is highly susceptible to procedural failures. As is clear from the '947 patent, the strength of data protection afforded by encryption is matched by the potential of data loss. In order to change or revoke access by any client to objects stored by the distributed filesystem, the objects must be successfully read and then re-encrypted with different keys. Any client failure leading to the loss of the client key results in a loss of the client stored data. While an encryption algorithm accommodating a master key might be used, such algorithms are inherently less secure and thereby would compromise the security of the stored data. Even if a master key algorithm is used, there remains the security control problem of managing multiple master keys.

Consequently, there is a need for a centrally manageable system capable of providing comprehensive security for network attached storage systems.

### SUMMARY OF THE INVENTION

Thus, a general purpose of the present invention is to provide a network media access controller that implements robust, centrally manageable storage security.

This is achieved in the present invention by a secure storage access controller that provides for the proxy routing of data transfer requests and responses between network clients and storage servers. The controller includes first and second network interface processors coupleable to client and data storage networks and a plurality of data packet processors coupled to the first and second network interface processors. Each data packet processor is operative to terminate respective client network connections routed to the plurality of data packet processors through the first network interface processor and to establish respective storage network connections through the second network interface processor. The data packet processors provide for the proxy transport of data transfer requests and responses between the client and storage network connections. Each the data packet processor includes an encryption engine operative to selectively encrypt media-level data contained within data transfer requests and responses as transported from the client network connections to the storage network connections.

An advantage of the present invention is that the network media access controller provides client initiator and target device independent storage security. The application of storage security as well as all management of storage security is effectively and efficiently removed to a centralized control point provided by the network media access controller.

Another advantage of the present invention is that storage security is implemented through media encryption of the network data streams routed through the network media access controller. Through data encryption at the media level, the implemented storage security is independent of the filesystem configuration, operating system, and source data application.

A further advantage of the present invention is that the network media access controller can be architecturally implemented fully within the local security domain. The network media access controller can be configured as a network gateway or proxy device within the local security domain and operated transparently for the benefit of the source data owners relative to external network-attached storage. All storage media accessed through the network media access controller is fully round-trip encrypted, yet all encryption keys and security parameters are centrally managed within the local security zone separate from the clients and external network-attached storage.

Still another advantage of the present invention is that the network media access controller can be operated as a storage firewall through utilization of multiple data transfer and data access control policies implemented in the operation of the network media access controller. Transport, access, and media policies can be operationally implemented to filter data transport, manage key usage, and map media resources to define the presentation and use of storage accessible through the network media access controller.

Yet another advantage of the present invention is that the network media access controller supports scalable, wire-speed media-level encryption to enable storage security for high-throughput network-attached storage systems. The encryption function can be implemented using public or private key encryption algorithms and can be applied to any transport storage protocol.

### BRIEF DESCRIPTION OF THE DRAWINGS

These and other advantages and features of the present invention will become better understood upon consideration of the following detailed description of the invention when considered in connection with the accompanying drawings, in which like reference numerals designate like parts throughout the figures thereof, and wherein:

FIG. 1 provides a system block diagram illustrating use of a network media access controller in accordance with the present invention;

FIG. 2 illustrates multiple alternate architectural uses of a network media access controller in accordance with the present invention;

FIG. 3 is simplified block diagram of the system architecture of a network media access controller constructed in accordance with a preferred embodiment of the present invention;

FIG. 4 is simplified block diagram of a control processor used in a network media access controller constructed in accordance with a preferred embodiment of the present invention;

FIG. 5 is simplified block diagram of a network interface processor used in a network media access controller constructed in accordance with a preferred embodiment of the present invention;

FIG. 6 is simplified block diagram of a first crypto processor used in a network media access controller constructed in accordance with a preferred embodiment of the present invention;

FIG. 7 is simplified block diagram of a second crypto processor used in a network media access controller constructed in accordance with a preferred embodiment of the present invention;

FIG. 8 illustrates the structure of at network data packet presenting media-level data for processing in accordance with a preferred embodiment of the present invention;

FIG. 9 illustrates an exemplary virtual initiator to target mapping provided by through a media policy control file in accordance with a preferred embodiment of the present invention;

FIG. 10 is a control and data flow diagram illustrating the processing of an iSCSI protocol network data packet in accordance with a preferred embodiment of the present invention;

FIG. 11 is a control and data flow diagram illustrating the preferred implementation of media-level encryption in accordance with the present invention;

FIG. 12 provides a transition state diagram detailing the storage system connection phase processing performed in accordance with a preferred embodiment of the present invention;

FIG. 13 provides a transition state diagram detailing the storage system media discovery phase processing performed in accordance with a preferred embodiment of the present invention;

FIG. 14 provides a transition state diagram detailing a first form of storage system media-level data read processing performed in accordance with a preferred embodiment of the present invention;

FIG. 15 provides a transition state diagram detailing a second form of storage system media-level data read processing performed in accordance with a preferred embodiment of the present invention;

FIG. 16 provides a transition state diagram detailing a first form of storage system media-level data write processing performed in accordance with a preferred embodiment of the present invention;

FIG. 17 provides a transition state diagram detailing a second form of storage system media-level data write processing performed in accordance with a preferred embodiment of the present invention;

FIG. 18 provides a transition state diagram detailing the handing of other system media commands as performed in accordance with a preferred embodiment of the present invention; and

FIGS. 19 and 20 provides a transition state diagram detailing the closing of storage system media-level data sessions and TCP connections in accordance with a preferred embodiment of the present invention.

### DETAILED DESCRIPTION OF THE INVENTION

The present invention provides storage security over data stored in network-attached storage systems that are at least logically remote relative to client computer systems that are the nominal owners of the remotely stored data. While the network-attached storage systems contemplated for use in connection with the preferred embodiments of the present invention utilize the iSCSI protocol as the basis for network storage data transfers, the present invention is not limited to use of the iSCSI protocol. Rather, the present invention is equally applicable to any network protocol, communicated over any media, that transports a data storage protocol, of which the SCSI protocol is one example. The present invention is equally applicable to fibre channel over IP (FCIP) and storage over IP (SoIP) protocols and is thus generally to any other combination of storage and transport protocols. It is therefore to be understood that the following description is of a preferred iSCSI-based embodiment of the present invention, but is not to be construed as limited to use of the iSCSI protocol.

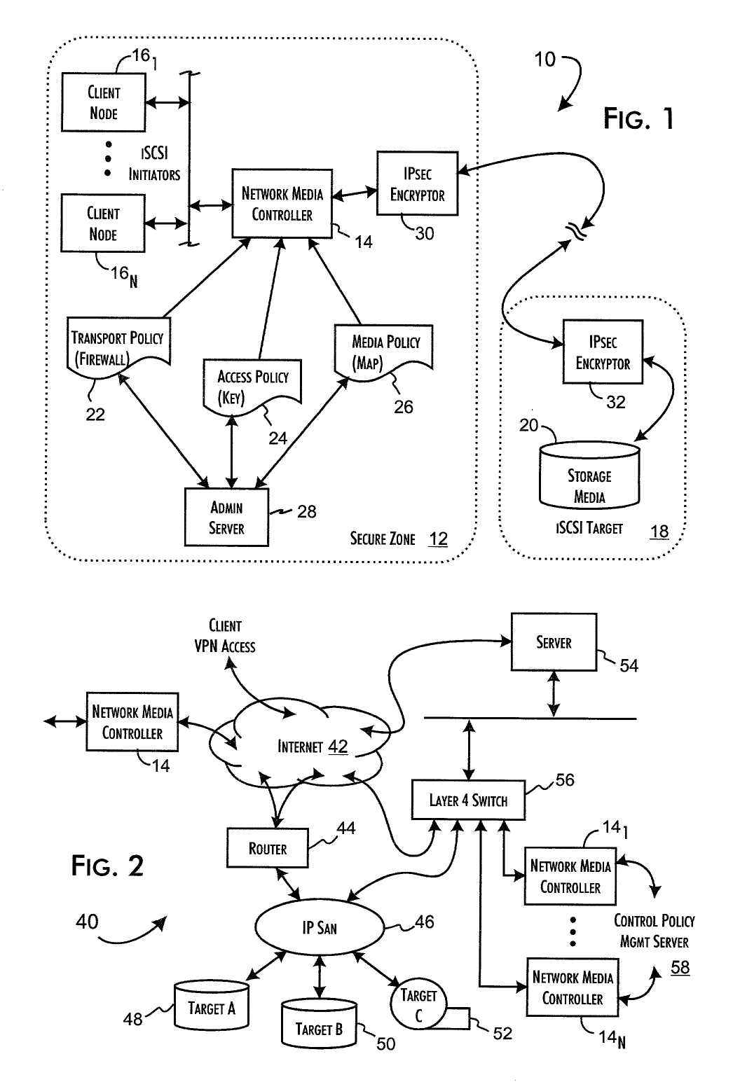

A generic application and embodiment 10 of the present invention is shown in FIG. 1. A secure network zone 12 includes a network media access controller 14 and any number of different clients 16_{1-N} that are nominal source data owners that operate as at least logically separate initiator iSCSI nodes. The network media access controllers 14 is preferably configured to appear as a target iSCSI network entity to the clients 16_{1-N}. Preferably operating in an iSCSI network proxy mode, the network media access controller 14 acts as an independent initiator of equivalent iSCSI requests to a network-attached storage system 18. The logically external storage system 18 includes one or more iSCSI target nodes 20 that provides persistent data storage. Alternately, the network media access controller 14 can operate as a network gateway device that operates to pass network data packets between the clients 16_{1-N} and iSCSI targets 20.

The primary function of the network media access controller 14 is to provide storage security for client data stored by the iSCSI targets 20. The network media access controller 14 preferably operates to encrypt the media-level data contained in selected iSCSI network data packets directed to any of the iSCSI targets 20 and correspondingly decrypt the media-level data in returned iSCSI data packets. In accordance with the present invention, media-level data is the SCSI data payload within an iSCSI network data packet. The presence of such media-level data is preferably identified by examination of the SCSI command or command response embedded within a corresponding iSCSI network data packet. In order to track the command/data association and recognize the various read and write command sequences, the network media access controller 14 preferably implements a SCSI state machine to track the command/data sequences. The state machine is preferably also used to acquire device geometry and target configuration information from the different iSCSI targets 20 by monitoring non-data transfer SCSI command and response exchanges between the external iSCSI initiators and targets. Alternately, pre-defined device geometry and target configuration information can be manually provided to supplement or override potentially insufficient or incorrect information that might be provided from the iSCSI targets.

In the preferred embodiments of the present invention, the network media access controller 14 implements a number of additional functions related to media access management. Preferably, a storage firewall function can be configured through the specification of a transport policy 22 presented as a data file to the network media access controller 14. In the preferred embodiments of the present invention, the contents of this data file, representing the parameters of the transport policy 22, are entered through a command interface supported by the network media access controller 14. The transport policy 22 preferably specifies various filtering rules that determine which network data packets will be selectively accepted for transport through the network media access controller 14. The filter rules can define allowable source and destination IP addresses, address ranges and TCP ports as well as protocols and transport directions. The filter rules also preferably define authentication and operation specific constraint rules. In the preferred embodiments of the present invention, the authentication rules define whether media access requires user, client, or a combination of user and client authentication. User authentication requires the iSCSI user name and password associated with a connection match a rule provided name and password. Client authentication requires the client computer IP address match a rule provided IP address or address range. A TCP port match may also be required. These authentication rules may be specified on a per LUN or volume basis.

Preferably, the authentication rules can be specified against specific SCSI command operations. In particular, different authentication rules may define different users or user groups permitted to read media data, write media data, format a volume, or issue a mode select. Other SCSI command operations can also be specified. This administratively permits, for example, defined users to read and write data to a volume, but prevent the users from formatting the volume or LUN, or changing the mode of the LUN. Conversely, defined administrative users can be permitted through the authentication rules to format LUNs and copy volumes, but not read or write media data. The authentication rules thus support a fine-grained transport and media access control mechanism that effectively implements a storage firewall function.

An access policy 24, also presented as a data file to the network media access controller 14, preferably specifies the encryption keys and related parameters applicable to the data storage resources of the iSCSI targets 20. Preferably, encryption keys are allocated on a per volume basis, where a volume ultimately corresponds to a unique portion or partition of a storage device LUN that can be resolved from the iSCSI target name as provided in the iSCSI header portion of a network data packet. In accordance with the preferred embodiments of the present invention, the volume association of encryption keys corresponds to the iSCSI target names terminated by the network media access controller 14.

Virtual, as well as real, media allocations are supported through the proxy operation of the network media access controller 14 based on media allocation mappings provided by a media map policy 26 data file. In proxy operation, the network media access controller 14 terminates iSCSI sessions relative to the clients 16_{1-N} and separately initiates iSCSI sessions with the real iSCSI targets 20. These internal iSCSI target names supported by the network media access controller 14, representing virtualized iSCSI targets, are therefore fully distinct from the external iSCSI names of the iSCSI targets 20.

The media policy 26 preferably includes map lists of the internal iSCSI target names recognized by the network media access controller 14 and the external iSCSI target names accessible by the network media access controller 14. An initiator-side to target-side mapping, establishing a correspondence between the virtualized internal and real external iSCSI target names, is also provided by the media policy 26. Although this initiator to target mapping is nominally provided statically by the media policy 26, a basic mapping can also be created dynamically by an automated process of discovering the available external iSCSI target 20 names, such as through inquiry operations directed to the iSCSI target 20 entity, and then permuting the names relative to the network media access controller 14 to establish a supported set of internal iSCSI target names.

In the simplest configuration, a one-to-one or real correspondence is defined by the initiator to target mapping of the media policy 26. This real media allocation nominally supported by the media policy 26 can be extended, in accordance with the present invention, to further virtualize the volumes of the iSCSI targets 20 at least with respect to the clients 16_{1-N}. Multiple modes of virtualization are possible. In one mode, the media policy 26 may define multiple virtual volumes within any one real volume by mapping different LBA offset ranges within a real LUN to different virtual iSCSI targets of corresponding size. These resulting virtual LUNs then appear as distinct iSCSI targets to the clients 16_{1-N}. Each virtual iSCSI target can then be specified as having a corresponding unique encryption key by corresponding allocation of keys under the access policy 24. This permits keys to be allocated to whatever level of granularity may be deemed appropriate in managing the security issues associated with the data.

Another media allocation mode supports remapping of an iSCSI target name, as specified by an iSCSI initiator, to a completely different iSCSI target name. This permits the data contents of one volume to be moved from one LUN to another, perhaps on an entirely different SCSI storage device within an entirely different iSCSI target entity. This real movement of the target data is transparent to the clients 16_{1-N}, as the iSCSI target named used by the iSCSI initiators can be maintained unchanged. The access policy 24, by associating the keys with the iSCSI target names supported by the network media access controller 14, can also be maintained unchanged. Any change in the external iSCSI target 20 name need only be reflected in an updated media policy 26.

A combination of the virtualization and remapping media allocation modes can also be supported by the media policy 26. Virtual volumes can be equally remapped through the media policy 26 to other real and virtual volumes. Thus, the movement of data from one virtual LUN to any other real or virtual LUN, as may be needed in maintenance of the iSCSI target 20 storage space, can be managed transparently to the clients 16_{1-N}.

In accordance with the present invention, the transport, access, and media policies 22, 24, 26 are managed through a centralized policy authority performed by an administrative server 28. Preferably, a GUI-based application is executed by the administrative server 28 to prepare and pass the transport, access, and media policies 22, 24, 26 to the network media access controller 14. By establishing the administrative server 28 as the policy authority over at least the access policy for encryption keys, a three-tier security system, consisting of client, media, and storage site security, is established. The client security tier covers the management of user access and configuration of the host systems associated with the client nodes 16_{1-N}. The storage site tier covers the security of the physical storage resources, including the ongoing management and maintenance of the various storage devices that make up the local network-attached storage system 18. The media access tier covers at least storage security over the local network-attached storage system 18. The media access tier also preferably includes the management and effective configuration of the virtual and real storage resources as well as firewall filtering of connections between the clients 16_{1-N} and the network-attached storage system 18. While the administrative server 28 may be physically implemented as one of the clients 16_{1-N}, the present invention enables the policy authority function to be centrally performed entirely separate from the clients 16_{1-N}. Further, the authority function can be performed almost entirely separate from the iSCSI targets 20, requiring only to be provided with any iSCSI target name changes made in the external maintenance of the iSCSI target 20 storage space.

The network media access controller 14 of the present invention can be used in combination with other network devices. In particular, the present invention contemplates use of IPsec encryption gateways 30, 32 with the network media access controller 14 to provide transport security. The IPsec encryption gateways 30, 32 may be of conventional design and implementation, though preferably are constructed and operate in accordance with the IPsec encryption gateways 30, 32 described in co-pending applications SCALABLE NETWORK GATEWAY PROCESSOR ARCHITECTURE, Ser. No. 09/976,322, by Pham et al., and LOAD BALANCED SCALABLE NETWORK GATEWAY PROCESSOR ARCHITECTURE, Ser. No. 09/976,229, by Pham et al., both of which are assigned to the Assignee of the present Application and are expressly incorporated herein by reference.

The network configuration 40 shown in FIG. 2 illustrate the architectural flexibility of the present invention in providing storage security. Clients can connect through a local network media access controller 14, the Internet 42, and a router 44 to an IP SAN 46 to any number of fixed media 48, 50 and removable media 52 iSCSI target nodes.

Alternately, clients can access the IP SAN 46 by remotely connecting via virtual private networks (VPN) to a server 54 that provides local connectivity through a layer-4 switch 56 to an array of network media access controllers 14_{1-N}. The media-level encrypted iSCSI traffic is then routed through the layer-4 switch 56 to the IP SAN 46 either directly or through the Internet 42 and router 44, depending on the physical location of the IP SAN 46. In accordance with the present invention, the array of network media access controllers 14_{1-N} is preferably managed by a single central policy management server 58 in place of separate administrative servers 28.

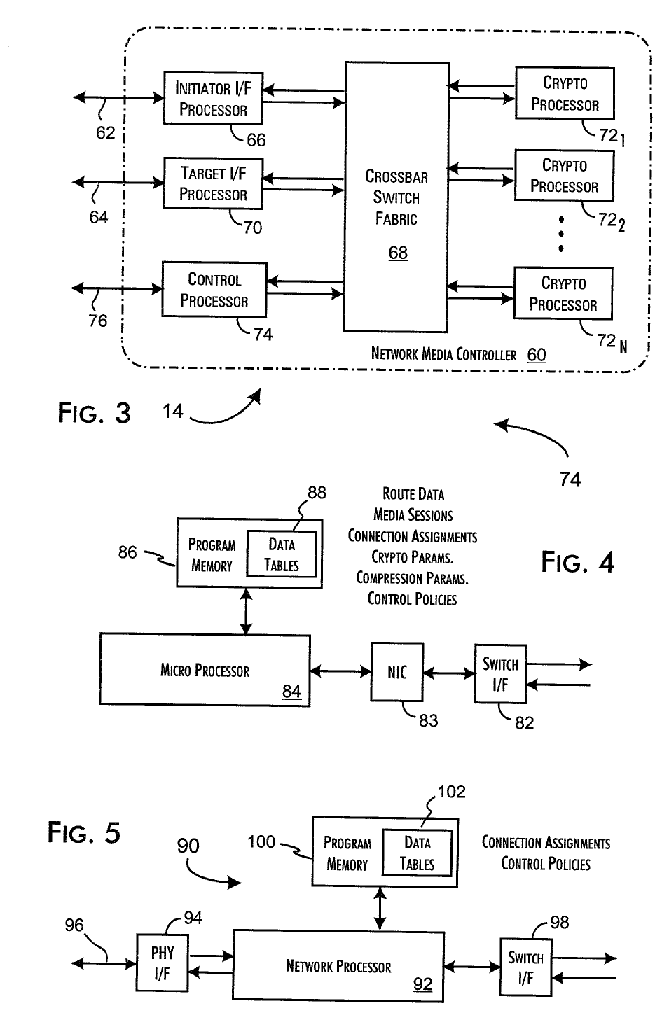

A wire-speed capable, scalable network media access controller 60, representing a preferred architectural embodiment of the network media access controller 14 of the present invention, is shown in FIG. 3. The network media access controller 60 preferably supports a separate physical interfaces to an initiator connected LAN 62 and a target connected LAN 64. Where the network media access controller operates as a network proxy device, the initiator and target LANs 62, 64 may be the same or different physical LANs. The initiator LAN 62 preferably connects an initiator interface processor 66, capable of performing high-speed network data packet processing, to a high-speed packet switch fabric 68. A target interface processor 70 similarly connects the target LAN 64 to the switch fabric 68.

The initiator and target interface processors 66, 70 connect through the switch fabric 68 to a scalable array of crypto processors 72_{1-N}, which, in aggregate, perform the core control and compute intensive functions of the network media access controller 60. For the preferred embodiments of the present invention, the initiator interface processor 66 logically allocates TCP connections from external iSCSI initiators to the array of crypto processors 72_{1-N} based on a connection load-balancing algorithm. In proxy operation, the crypto processors 72_{1-N} preferably terminate these TCP connections and independently initiate corresponding connections with external target iSCSI nodes connected through the target interface processor 70. In operation, network data packets are routed through a corresponding crypto processor 72_{1-N} based on the TCP connection identification contained within each network data packet. The crypto processors 72_{1-N} selectively process and rewrite each network data packet to implement proxy routing, perform media-level processing of the embedded media payload data, and to update other data packets fields consistent with the processing of the media-level payload data. The processing performed by the crypto processors 72_{1-N} is bidirectional, essentially dependent on the direction of the network data packet based media-level data transfer through the network media access controller 60.

A control processor 74 connects to the switch fabric 68 to provide management and configuration functions in support of the internal operation of the network media access controller 60. Global management and configuration data defining the implemented policies, network connections, and storage resources maintained accessible through the network media access controller 60 are stored by the control processor 74. While the initial data is derived from the policy files 22, 24, 26, the data is dynamically updated from the initiator and target interface processors 66, 70 and the individual crypto processors 72_{1-N}. Portions of the data are provided on query back to the initiator and target interface processors 66, 70 and the individual crypto processors 72_{1-N}. These updates and queries are preferably performed as logically out-of-band data transfers relative to the network data packet transfers between the initiator and target interface processors 66, 70 and the individual crypto processors 72_{1-N}.

The control processor 74 also provides a control interface to the administrative server 28. Initial and updated control policy data 22, 24, 26 is provided to the control processor 74 and dynamic configuration, status and statistical performance data are returned through the control interface. In the preferred embodiments of the present invention, this control interface is accessible typically by way of the initiator LAN 62 using an IP address uniquely allocated to the network media access controller 60. Alternately, a separate LAN interface 76 can be implemented to provide an effectively private control access path between the administrative server 28 and network media access controller 60.

In the preferred embodiments of the present invention, the network media access controller 60 utilizes IBM Packet Routing Switches PRS28.4G (IBM Part Number IBM3221L0572), commercially available from IBM Corporation, Armonk, N.Y., as the basis for the switch fabric 68. Pairs of the Packet Routing Switches are connected in a speed-expansion configuration to implement sixteen input and sixteen output ports and provide non-blocking, fixed-length data packet transfers at a rate in excesses of 3.5 Gbps for individual port connections and with an aggregate bandwidth in excess of 56 Gbps.

For in-band network data packet transfers, the initiator and target interface processors 66, 70 connect to the switch fabric 68 through multiple ports of the fabric 68 to establish parallel packet data transfer paths though the switch fabric 68 and, thus, to divide down, as necessary, the bandwidth rate of the connected networks 62, 64 to match the individual port connection bandwidth of the switch fabric 68. Thus, for 4 Gbps network 62, 64 connections, the initiator and target interface processors 66, 70 each implements at least three port input and output connections to the switch fabric 68. For the preferred embodiment of the network media processor 60, which supports one Gigabit Ethernet connections, the initiator and target interface processors 68, 70 each require just single input and output port connections to the switch fabric 68 to fully support the bandwidth requirements of the in-band network data traffic.

Each of the crypto processors 72_{1-N} preferably implements single input and output port connection to the switch fabric 68. Due to the core control and compute intensive functions implemented by the crypto processors 72_{1-N}, the throughput capabilities of the crypto processors 72_{1-N} are expected to be less if not substantially less than the bandwidth capabilities of a single switch fabric port connection.

The control processor 74 preferably also requires just single input and output port connections to the switch fabric 68. Like the crypto processors 72_{1-N}, the management and configuration functions performed by the control processor 74 are not anticipated to exceed the bandwidth capabilities of single bidirectional pair of switch fabric port connections.

Alternately, a lower aggregate throughput switch fabric 68 can be cost effectively implemented using a Gigabit Ethernet switch device, such as the BCM5680, commercially available from Broadcom Corporation, Irvine, Calif. Single gigabit connections through an eight-port Gigabit Ethernet switch-based fabric 68 can directly support an array of up to five crypto processors 72_{1-N} to fully support one Gigabit wire-speed iSCSI data transfers over the connected LANs 62, 64.

As generally shown in FIG. 4, the control processor 74 is preferably implemented using a conventional embedded processor design and executes an embedded version of the Linux® network operating system. An ASIC switch interface 82, coupled through a conventional network interface core 83, enables a conventional embedded microprocessor 84, such as an Intel® Pentium®-III series processor, to communicate out-of-band data packets through the switch fabric 68 with the initiator and target interface processors 66, 70 and crypto processors 72_{1-N}. Alternately, an available direct interface port preferably on the initiator interface processor 66 can be used to host bidirectional communications between the control processor 74 and the initiator LAN 62 and any other processor connected to the switch fabric 68.

The embedded operating system is executed from a program memory 86, which is also used to store management and configuration information in data tables 88. Table 1 summarizes the management and configuration data held in the data tables 88.

TABLE 1
Management and Configuration Data

| | |
|---|---|
| 1. | IP filter rules: defining permitted combinations of IP addresses, port |
| | numbers, and protocols for transport through the network media |
| | access controller; initially defined through the Transport policy; |
| | dynamically updateable by the administration server. |
| 2. | Initiator to target volume mappings: establishing the logical |
| | association of targets terminated by the network media access |
| | controller and the real targets accessible through the network media |
| | access controller; mapping preferably includes the full iSCSI names |
| | of the logical and real targets sufficient to support proxy operation; |
| | real target map entries preferably include data defining volume |
| | compression status and control parameters and volume encryption- |
| | type and control parameters; initially defined by the Media policy; |
| | dynamically updateable by the administrative server. |
| 3. | Encryption keys assignments: to uniquely defined volumes, |
| | preferably corresponding to the initiator map of the target |
| | volumes terminated by the network media access controller; |
| | initially defined by the Access policy; dynamically |
| | updateable by the administrative server. |
| 4. | Connection data: identifying the established media sessions and |
| | session identifiers, established TCP connections and connection |
| | identifiers, and the TCP connection to crypto processor associations; |
| | dynamically established through the ongoing operation of the network |
| | media access controller; provided by and subsequently queriable by |
| | the interface and crypto processors; reportable to the administrative |
| | server. |
| 5. | Statistical data: accumulated from the interface and crypto processors |
| | to reflect the internal status and performance of the network media |
| | access controller; reportable to the administrative server. |
| 6. | Authentication data: table of user names, passwords, and IP |
| | combinations; used in support of user, client, and user/client |
| | authentication; user authentication verifies against the iSCSI login |
| | user name and password; client authentication verifies against a client |
| | IP and IP mask specification. |
| 7. | Policy enforcement data: rule set defining access rights and privileges |
| | against user/client identifications and defined volumes; specification |
| | of permitted operations (read, read/write, format, mode select, verify, |
| | others) per user, client, or user/client for an identified volume. |

While the detailed function of the initiator and target interface processors 66, 70 is somewhat different, the processors 66, 70 utilize substantially the same interface processor 90 implementation, as shown in FIG. 5. Preferably, a high-performance network processor 92 is used to implement the core functions of the interface processor 90. In the preferred embodiment of the present invention, the network processor 92 is an IBM PowerNP NP4GS3 Network Processor (Part Number IBM32NPR161 EPXCAE133), which is a programmable processor with hardware support for Layer 2 and 3 network packet processing, filtering, and routing operations at effective throughputs of up to 4 Gbps. The network processor 92 supports a conventional bidirectional Layer 1 physical interface 94 to a network 96.

The preferred network processor 92 includes a basic serial-data switch interface 98 that supports two uni-directional data-aligned synchronous data links compatible with multiple port connections to the switch fabric 68. Preferably, the switch interface 98 can be expanded, as needed, through trunking, to provide a greater number of speed-matched port connections to the switch fabric 68.

A high-speed memory 100 is provided to satisfy the external memory and program storage requirements of the network processor 92. Included within this memory 100 is a data table 102 providing a dynamic data store for programmed and accumulated filtering and routing information. Preferably, for both the initiator and target interface processors 66, 70, the data table 102 is initially programmed with IP filter rules provided from the control processor 74, which are then used to define and constrain the allowable connections to and through the network media access controller 60.

For the initiator interface processor 66, the data table 102 will store TCP connection information initially developed in response to received TCP connection requests from external iSCSI initiators. Where the connection is allowed under the applicable IP filtering rules, the media session and connection identifiers are recorded in the data table 102 along with the identification of an assigned crypto processor 72_{1-N}, as selected by a load-balancer algorithm, to handle the TCP connection data packet processing. The media session, connection and crypto processor identifications are copied to the control processor 74.

The target interface processor 70 will also store TCP connection information in the data table 102, though based on TCP connection requests initiated from the crypto processors 72_{1-N}. The TCP connection information is stored with an identification of the requesting crypto processors 72_{1-N} to permit return network data packets to be routed by the target interface processor 70 to the connection assigned crypto processor 72_{1-N}.

A first embodiment 110 of a crypto processor 72_{1-N} is shown in FIG. 6. The crypto processor 110 includes a network processor 112, which is also preferably an NP4GS3 Network Processor, and a switch fabric interface 114. A program memory 116 provides for the external memory and program requirements of the network processor 112. Data tables 118 store the access and media policy related information needed by a crypto processor 72_{1-N} to process the network data packets provided through the TCP connections allocated to that particular crypto processor 72_{1-N}. Preferably, the data tables 118 are populated as allocated TCP connections are opened. Where a TCP connection request opens a new media session, the control information describing the new media session is copied to the control processor 74, where the information is then held available for other crypto processors 72_{1-N}. By default, preferably, each crypto processor 72_{1-N} queries the control processor 74 for a known media session upon receiving a TCP connection request and uses any returned information to abbreviate establishing the connection.

In the preferred embodiments of the present invention, the crypto processor 110 performs media-level data encryption on select data packets received through a TCP connection. The encryption operation can be performed using a simple shared key encryption algorithm or a public key encryption algorithm. In general, a numerically intensive computation, such as an encryption operation, is considered compute intensive for purposes of the present invention.

The media-level data identified by operation of the network processor 112 is preferably passed through a high-speed data interchange interface to a dedicated encryption/decryption engine 120 for processing. For the crypto processor embodiment 110, the engine 120 is preferably a BCM5840 Gigabit Security Processor, commercially available from Broadcom Corporation, Irvine, Calif. The BCM5840 processor implements a highly integrated symmetric cryptography engine providing hardware support for multiple encryption and decryption algorithms. Utilizing the BCM5840, a crypto processor 110 is capable of a minimum sustained effective public key encryption/decryption and authentication rate of 2.4 Gbps.

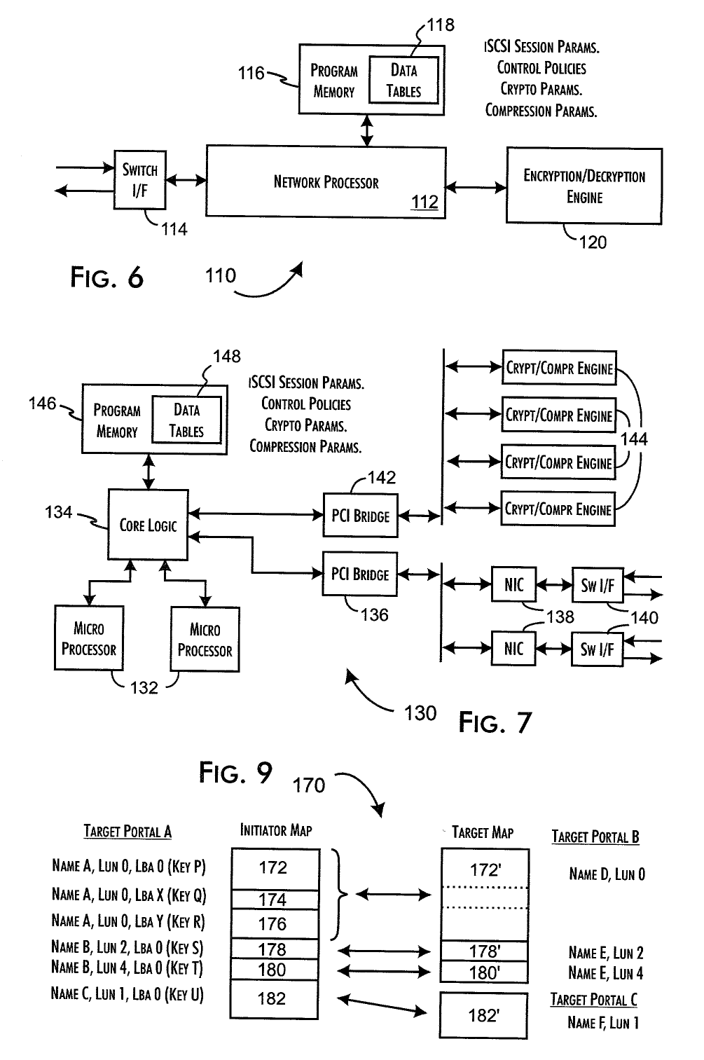

A second and preferred embodiment 130 of a crypto processor 72_{1-N} is shown in FIG. 7. Where flexibility and high-integration are desired, a high-performance multi-processor system can be used in place of a dedicated, limited function network processor to perform level-2 through 7 processing of network data packets and implement storage data encryption and compression. For the preferred crypto processor 130, dual 1.2 GHz Pentium®-III series processors 132 are connected through a core logic bridge 134 and a first PCI bridge 136 to an array of conventional Gigabit Ethernet network interface cores 138, and high-speed serial switch fabric interfaces 140. The core logic bridge 134 is preferably a high-performance bridge, such as the HE-SL North Bridge chip, commercially available from ServerWorks, Inc., Santa Clara, Calif., that supports dual PCI-64/66 buses. The PCI bridge 136 is preferable an Intel 21154 (64/66 MHz) South Bridge chip. Two network and switch interfaces 138, 140 connect through the switch fabric 60 to the initiator and target interface processors 66, 70. Additional network and switch interfaces 138, 140 can be provided to support management and control access to the crypto processor 130.

A second PCI bridge 142 provides a connection from the second bus interface of the core logic bridge 134 to an array of crypto/compression engines 144, such as the HiFn 7851 Security Processor, commercially available from HiFn, Inc., Los Gatos, Calif. The HiFn 7851 implements a variety of encryption protocols and includes an embedded data compression engine. Alternately, a HiFn 7854 Security Processor can be used where public key encryption is desired, such as where the crypto processor is used to provide transport security as well, consistent with the VPN architecture described in the above identified co-pending applications.

The microprocessors 132 preferably execute a high-performance network operating system, such as Linux™, from a program memory 146, which may be loaded from a disk drive hosted by the control processor 74. In operation, the microprocessors 132 selectively processes received network data packets to locate and pass media-level data for processing by the crypto/compression engines 144. Data tables 148, provided in the program memory 146, are used to store information in the same manner as data tables 118.

The programmed procedural operation of the microprocessors 132 permit network as well as non-network specific operations, such as data compression, to be conveniently implemented. Simple data compression algorithms could be implemented directly by the micro processor core 132. Preferably, the integral compression engines of the crypto/compression engines 144 are utilized to implement a high-performance lossless data compression algorithm with a throughput rate of up to 400 Mbits/sec per engine. Since, in accordance with the preferred embodiments of the present invention, streaming, but not block media-level data is subject to being compressed by the crypto processor 130, the use of a programmed, procedural micro processor core 132 simplifies handling different TCP connections with different desired treatments of media-level data.

As illustrated in FIG. 8, the preferred embodiments of the present invention particularly provide for compute intensive processing of media-level data contained within iSCSI protocol network data packets. To locate the media-level data, the encapsulated headers within network data packets routed to the network media access controller 60 are progressively examined to locate media-level data payloads. Whether the SCSI command applicable to particular media-level data is a read or write generally determines whether the corresponding media-level data payload is to be encrypted or decrypted. While the preferred embodiments are particularly directed to discovering media-level data within iSCSI protocol network data packets, the present invention is equally applicable to processing network data packets encapsulating or hosting any data transfer protocol, of which the iSCSI protocol a representative example.

An iSCSI protocol network data packet 150, generically referred to as an iSCSI data packet, conventionally includes IP header field 152 that encapsulates a TCP packet 154. The IP packet 152 header field includes IP source and destination address and port number subfields. In accordance with the preferred embodiments of the present invention, the proxy operation and media level processing of network data packets by the network media access controller 60 involves rewriting the network data packets to selectively update the contained data. Such rewriting may, as optimal depending on implementation details, involve either copying the packet contents to a new data packet structure or rewriting the contents of subfields in place within an existing data packet structure. Thus, in the simplest case, the IP subfields of a network data packet, as received by a crypto processor 72_{1-N}, are preferably rewritten with proxy-defined source and destination addresses and port numbers before being resent by the network media controller 60.

The TCP packet 154 encapsulates a formal iSCSI data packet 156, which includes iSCSI header, payload, ECC, and trailer sections. The iSCSI header and payload data include subfields storing a media session identifier and, to support multiple TCP connection media sessions, a connection identifier for the iSCSI data packet 156. Other subfields occur as needed to provide iSCSI initiator and target names and the storage device LUN and LBA for the intended iSCSI target. These iSCSI subfields, and the address and port subfields of the IP packet header, may also be selectively rewritten based on the provided media policy 26.

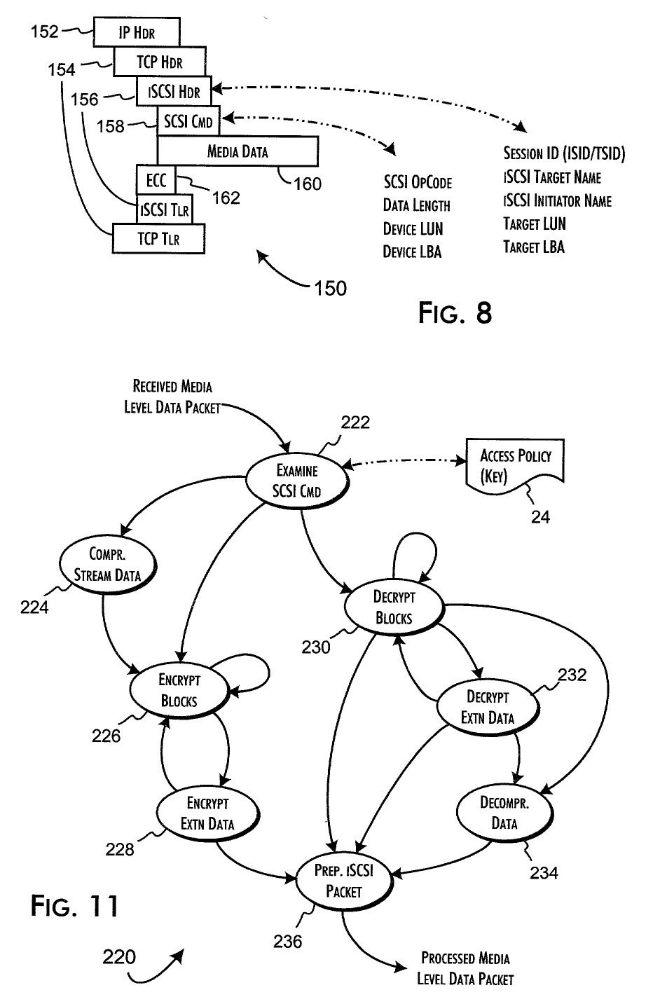

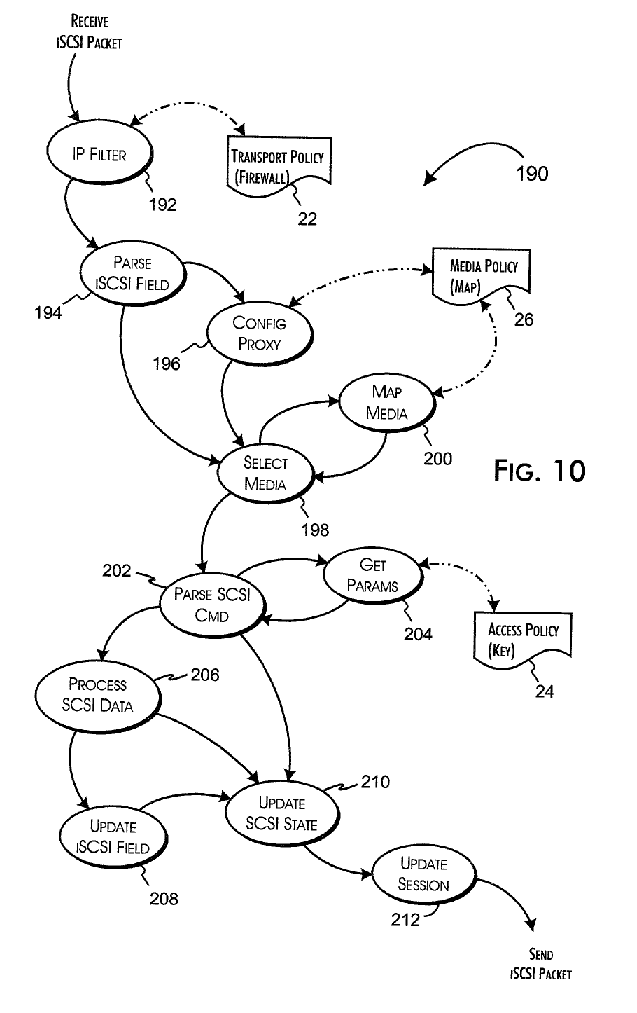

As generally shown in FIG. 9, an exemplary media policy 170 defines initiator and target maps that are implemented by the network media access controller 60. The initiator map is defined for the iSCSI target portal implemented by the network media access controller 60, which is identified by one or more combinations of IP addresses and TCP port numbers. The target map references iSCSI targets available through external iSCSI target portals, also identified by respective combinations of IP addresses and TCP ports, that are accessible by the network media access controller 60 through the target LAN 64. The initiator map is used to virtualize the available iSCSI targets and serve as a basis for associating access policy information with the iSCSI targets.

For the exemplary media policy 170, the initiator map reflects a single iSCSI Portal A implemented by the network media access controller 60, while the target map references external iSCSI targets available through iSCSI Portals B and C. Initiator map entries represent multiple iSCSI targets 172, 178, 180, 182, each with a defined iSCSI target name (Portal A:Name A-C) that correspond to the available target map iSCSI named targets 172′, 178′, 180′, 182′. Preferably, at least the initiator map is extended to distinguish LUN identified SCSI devices and, to represent separate partitions within a LUN as may be defined by a client filesystem, contiguous ranges of LBA values of a named iSCSI target. Preferably, entries qualified by LUN and LBA range take precedence over entries that only specify an iSCSI named target.

Thus, initiator map entries 172, 174, 176 correspond to a common virtualized iSCSI target named Portal A:Name A, which maps through the target map entry 172′ to an external iSCSI target named Portal B:Name D. The initiator map distinguished LBA ranges preferably correspond to partitions within the external iSCSI target Portal B:Name D. An iSCSI target Portal A:Name B:LUN 2 maps through an entry 178′ to Portal B:Name E:LUN 2 while iSCSI target Portal A:Name B:LUN4 separately maps through an entry 180′ to Portal B:Name E:LUN 4. Portal A:Name C:LUN 1 maps through entry 182′ to Portal C:Name F:LUN 1, demonstrating target portal redirection. In each instance, the initiator map entry supports the association of distinct keys with different distinguishable storage resources.

Again referring to FIG. 8, the payload portion of the iSCSI data packet 156 contains a SCSI command 158 as well as any referenced media-level data 160. Examination of the SCSI command 158 identifies whether media-level data 160 is included and the starting offset and length of the media-level data 160. Specifically, where the SCSI command 158 indicates that the media-level data is media read or write data, as opposed to status or other data, the media-level data 160 is selectively processed by encryption, compression, or both.

The access policy 24 is referenced to obtain the encryption key and related crypto control parameters defining the type and implementation of the encryption algorithm applicable to the iSCSI target node referenced by the iSCSI data packet 156. As generally indicated in FIG. 9, the access policy 24 associates encryption keys and crypto parameters logically against the initiator map entries. Thus, the virtual iSCSI targets accessible through the media access controller 60, down to discrete LBA ranges identified through the media policy 26, can have unique associated encryption keys and sets of crypto parameters. The access policy 24 also preferably stores compression parameters, identifying any applicable compression algorithm and providing compression control values, against the initiator map entries.

Media-level data processed through an encryption engine 120, 134 is rewritten to the media-level data field 160. To reflect this transformation of the media-level data, the error correction code value held by the data error correction code field 162 is then recomputed and rewritten. This conforms the iSCSI packet 158 to the conventional requirements of the iSCSI protocol.

The comprehensive operation of a network media access controller 60 is generally shown in the process flow 190 of FIG. 10. When a network data packet is received from the initiator or target LAN 62, 64, the initiator and target interface processors 70 filter 192 the data packet based on the transport policy 22. The filter 192 preferably excludes non-iSCSI protocol network data packets, except those provided to establish a TCP connection for an iSCSI session and those exchanged with an authorized administrative server 28 to manage and configure the network media access controller 60. The filter 192 also preferably excludes iSCSI protocol network data packets directed to or received from unauthorized iSCSI targets.

For iSCSI data packets received through an existing TCP connection, the interface processor 66, 70 internally routes the network data packet to a crypto processor 72_{1-N} assigned to handle the corresponding TCP connection, which is determined from the local data table 102 or by query of the control processor 74.

For new TCP connections, a crypto processor 72_{1-N} is assigned, selected based on a load-balancing algorithm, to handle the TCP connection until closed. Preferably, load-balancing is performed by a least-connections-assigned algorithm. The initiator interface processor 66 determines from the local data table 102 the crypto processor 72_{1-N} with the least number of open TCP connections assigned and adds the new TCP connection to that crypto processor 72_{1-N}. The new TCP connection assignment is reported to the control processor 74.

Alternately, the load-balancing algorithm can operate to take into account the effective activity of the different TCP connections. By query of the statistical data accumulated by the control processor 74 for the different open TCP connections, the load-balancing algorithm can select an available crypto processor 72_{1-N} based on a weighted combination of least-connection-assignments and loading. Since I/O data transfer loads are often highly aperiodic, such a load weighting may be inconsequential as a practical matter. Broadly distributing TCP connections associated with a single media session over the crypto processors 72_{1-N}, however, may minimize the occurrence of excessive load on any one crypto processor 72_{1-N} during an activity peak within the media session.

The network data packets are forwarded to the assigned crypto processor 72_{1-N}, either to complete the setup of an iSCSI session or, subsequently, to process iSCSI data packets. In the specific instance of an iSCSI data packet transferred within an existing iSCSI session, the assigned crypto processor 72_{1-N} first parses the iSCSI header subfields 194. In the preferred proxy-based embodiment, the IP header and iSCSI subfields are then rewritten to reference the proxy targets 196 based on the media policy 26. The initiator to target mapping is then examined 198 and the iSCSI initiator and target name mapping 200 is rewritten based on the media policy 26. These subfields, however, are not rewritten where the network media access controller 60 operates as a network gateway for iSCSI protocol transactions.

The SCSI command 158 contained within the iSCSI data packet is then parsed to identify the SCSI command function. An encryption key, the volume compression status, and related parameters are retrieved 204 from the access policy 24, depending on whether media-level data is present in the iSCSI data packet as determined from function specified by the embedded SCSI command.

Since the SCSI I/O transport protocol includes command and response phases, a SCSI state machine is preferably implemented by the crypto processors 72_{1-N} to track the phase transitions within each connection handled by a crypto processor 72_{1-N}. Thus, the media-level processing 206 of write data is performed in the command phase of a SCSI write command, while read data processing 206 is performed in the response phase following from a SCSI read command. Whenever media-level data is processed 206, the corresponding fields of the iSCSI data packet are updated 208, followed by an update of the SCSI state machine 210 and any session data 212, including session data sequence numbers. The processed iSCSI data packet is then passed by the crypto processor 72_{1-N} to the initiator or target interface processor 66, 70 for transfer onto the appropriate initiator or target LAN 62, 64.

Where an SCSI command or response does not include media-level data for processing 206, or where the processing 206 of the media-level data encounters an error condition, the SCSI state machine 210 and session data 212 are updated and, as appropriate, an iSCSI data packet is passed on to the initiator or target interface processor 66, 70.

The preferred operation 220 of the present invention in performing encryption and, optionally, compression processing of media-level data is shown in FIG. 11. Media-level data transfers are specified by SCSI commands as a transfer of a series of one or more data blocks. For random read/write capable block storage devices, such as hard disk drives, the initiator and target block correspondence must be maintained by the network media access controller 60. Therefore, the preferred embodiments of the present invention separately encrypt each data block of media-level data directed to a random read/write block storage device.

Media-level data transfers directed to sequential data storage devices, such as tape drives, are also specified as transfers of one or more data blocks. Since sequential media-level data is written and read as unitary data streams, initiator to target block correspondence need not be maintained. The preferred embodiments of the present invention therefore provide for the encryption and optional compression of media-level data written to sequential data storage devices.

The size of each data block referenced by a SCSI command is determined by the underlying device. For block storage devices, a typical block size is 512 bytes and at least logically corresponds to a disk data sector. Data blocks written to block storage devices must be block aligned to the underlying device. While the data block size is fixed for a particular block storage device, different block storage devices can and often do have different block sizes.

Sequential data storage devices have defined physical data block sizes and operate in either fixed or variable block size modes. In fixed block size mode, each write data block is written as one or more contiguous physical data blocks. In variable block size mode, the physical data block size represents the maximum write data block size that can be written to the device in a single write operation. There is, however, no underlying physical media block alignment requirement, which allows data blocks to be written beginning at any offset subject to the constraint that individual block writes are equal or less than the physical block size supported by a particular data storage device.

Media-level data received 222 in connection with a SCSI write data command is considered in connection with the access policy 24 for the named iSCSI target. The access policy 24 provides the necessary encryption key, compression state, and applicable encryption and compression parameters for the named iSCSI target. The media-level data may be first compressed 224 where the named iSCSI target is a sequential data storage device.

The media-level data is then encrypted 226 preferably using a strong block encryption algorithm. For block storage devices, the encryption algorithm block size used is preferably a word-aligned block size that most closely approaches the block size of the media-level data. For purposes of the present invention, word-alignment occurs on eight byte boundaries. Consequently, up to one word of the media-level data in each media-level data block is either left unencrypted or preferably encrypted 228 using a conventional non-block oriented encryption algorithm, such as XOR and hashing, as may be specified by the access policy 24. Each media-level data block provided in connection with the SCSI command is successively encrypted by first block encryption 226 and, to the extent that any extended data remains, non-block encrypted 228. While the extended media-level data, representing the differential between the encryption and media block sizes, is generally subject to a relatively weaker form of encryption, less than a word of each media-level data block is exposed by the weaker encryption and then only at intervals at least equal to the media block size.

For sequential data storage devices, a word-aligned encryption block size is chosen that is preferably evenly divisible into the total length, subject to compression, of the media-level data provided with the SCSI command. Larger block sizes are potentially preferred to optimize the performance of the encryption algorithm. Smaller sizes are preferred to minimize the amount of extended data remaining between a multiple of the encryption algorithm block size and the actual length of the compressed media-level data. Rather than use only a single fixed block size, the access policy 24 can possibly be used to specify a sequence or schedule of encryption block sizes that, in combination, may further minimize the size of any terminal fractional block of media-level data.

Preferably, media-level data directed to a sequential data storage device is successively block encrypted 226 based on a block encryption size that is less than the device specific block size. Any remaining media-level data, which is by definition less than the block encryption size used in encrypting the bulk of the media-level data, is then encrypted 228 using a non-block oriented encryption algorithm.

Media-level data, received 222 in connection with a SCSI read data command is decrypted 230, 232, with the decryption procedure depending on whether the named iSCSI target is a block or sequential data storage device. Where received from a sequential data storage device, the decrypted media-level data is decompressed 234 depending on the compression state defined for the named iSCSI target in the access policy 24. The processing of media-level data completes with the rewriting 236 the iSCSI data packet with the processed media-level data.

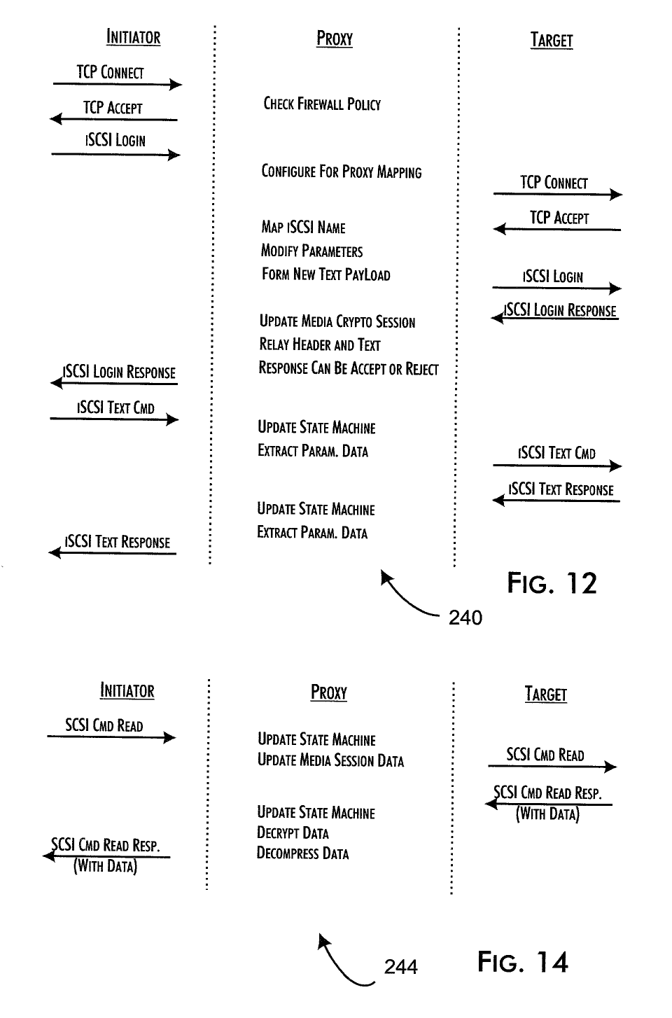

FIGS. 12 through 20 detail the preferred operational flow of the network media access controller 60 for iSCSI protocol network data transfers in accordance with the present invention. The flow 240 of FIG. 12 details the establishment of a new TCP connection for a new or existing iSCSI media session. The TCP connection request from an external iSCSI initiator is initially filtered through the basic IP address and TCP port rules of the transport policy and passed, subject to the load-balancer algorithm, to an available crypto processor 72_{1-N}. A TCP accept packet is returned to the iSCSI initiator. An iSCSI initiator login request is then received, including the user name and password associated by the client computer operating system with the iSCSI login request. Provided the iSCSI initiator login request is authorized under the transport policy rules, the crypto processor 72_{1-N} selects and initiates a TCP connection with a corresponding, external, named iSCSI target and issues an independent iSCSI initiator login request. On acceptance of the iSCSI login by the external named iSCSI target, the assigned crypto processor 72_{1-N} completes the iSCSI login with the external iSCSI initiator. A series of iSCSI text commands and responses are typically then exchanged through the assigned crypto processor 72_{1-N}. The assigned crypto processor 72_{1-N} receives each request and response, copies out any relevant parameter data passed between the external iSCSI initiator and target, updates the connection SCSI state machine, and, subject to proxy rewriting, passes on the request or response. The parameter data collected is updated to the control processor 74.

Where the TCP connection is recognized as part of an iSCSI media session established through a prior TCP connection, the assigned crypto processor 72_{1-N} can use the information collected during the initial iSCSI login of the media session to complete the current iSCSI login transaction. Recognition of the media session is performed by issuing a control message query to the control processor 74 by the assigned crypto processor 72_{1-N}. If the current login is the initial login for an iSCSI media session, the information progressively collected from the text command and response exchanges is passed to the control processor 74 for storage and subsequent reference.

Typically following completion of an initial media session iSCSI login, the external iSCSI initiator will investigate the configuration of the iSCSI target. As shown in FIG. 13, SCSI inquiry, mode sense, read capability and read block limits requests can be issued by the external iSCSI initiator. The assigned crypto processor 72_{1-N} receives each request, updates the connection SCSI state machine, and, subject to proxy rewriting, passes the request to the external named iSCSI target, provided the request is authorized under the transport policy rules.

The external named iSCSI target responds with a SCSI inquiry, mode sense, read capability, or read block limit response to the assigned crypto processor 72_{1-N}. The connection SCSI state machine is updated with each response received. The various response returned information, such as on-line status, data block size, storage capacity, device type, and hardware compression capability of the external named iSCSI target, are also recorded by the assigned crypto processor 72_{1-N} and passed to the control processor 74 for storage and subsequent reference. Finally, each response is passed, subject to proxy rewriting, to the external iSCSI initiator.

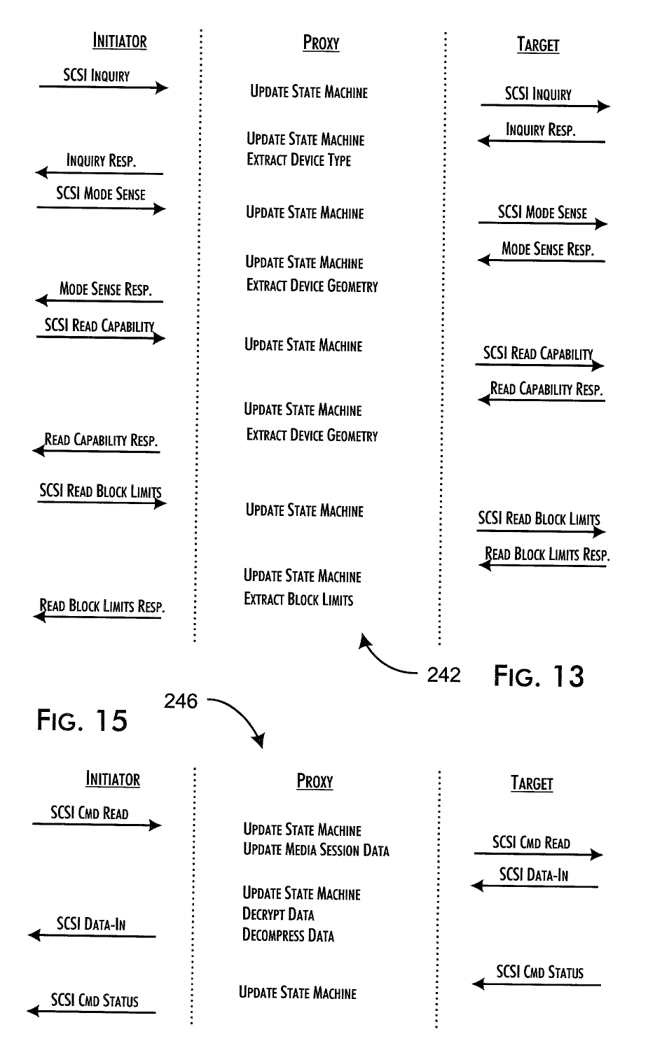

FIGS. 14 and 15 detail two different possible SCSI read command process flows. In the flow 244 of FIG. 14, a SCSI read command is received from the external iSCSI initiator and checked against the transport policy rules. The connection state machine and data tracking the current media session are updated. The SCSI read command, subject to proxy rewriting, is then issued to the external named iSCSI target.

A single SCSI read command response returns the media-level data referenced by the SCSI read command to the assigned crypto processor 72_{1-N}. The connection state machine is updated and the media-level data is decrypted and, as appropriate, decompressed. The processed media-level data is then rewritten into the read response network data packet, which is further rewritten for reverse proxy operation. The SCSI read response network data packet is then passed to the external iSCSI initiator.

The flow 246 of FIG. 15 is similar to the flow 244 except that the external named iSCSI target responds to the SCSI read command with an alternative SCSI data-in response. The SCSI data-in response is handled substantially the same as the SCSI read command response. The significant differences are that multiple SCSI data-in response can be sourced from the external named iSCSI target, ultimately terminating with a separate SCSI command status response. Preferably, the connection SCSI state machine recognizes and tracks the difference in SCSI flow responses.

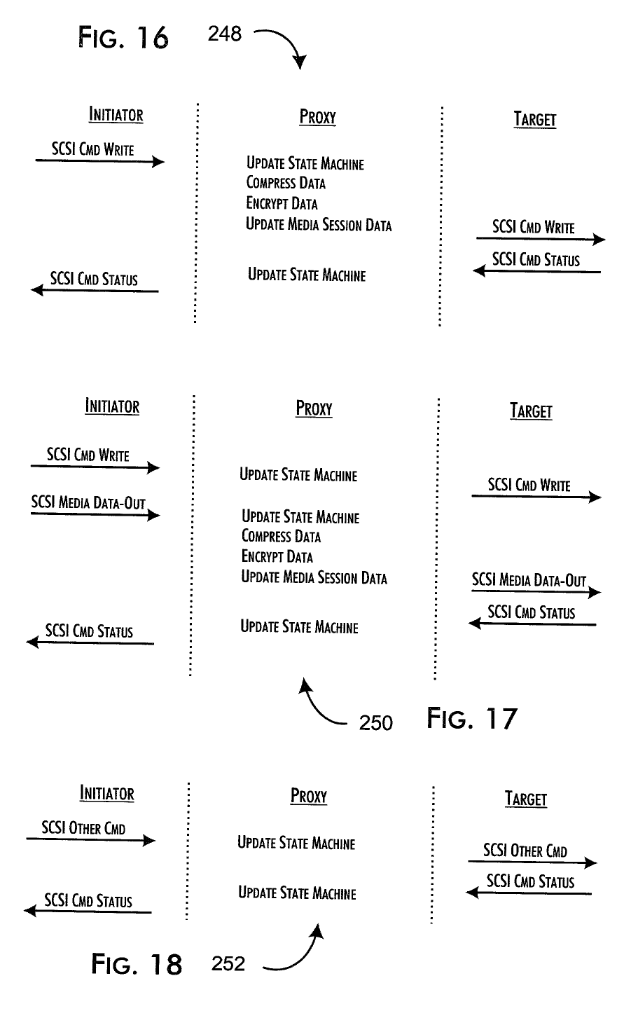

FIGS. 16 and 17 detail SCSI write data processes flows. In the process flow 248 of FIG. 16, a SCSI write command transfers media-level data from the external SCSI initiator to the assigned crypto processor 72_{1-N}. If the write is authorized under the transport policy rules, the connection state machine is updated and the media-level data is compressed, as appropriate, and encrypted. The media session data is updated and the rewritten iSCSI data packet is sent to the external named iSCSI target. When a corresponding SCSI command status response is returned, the assigned crypto processor 72_{1-N} again updates the connection state machine and returns, subject to proxy rewriting, the SCSI command status response to the external iSCSI initiator.

The flow 250 of FIG. 17 differs in that the external iSCSI initiator may issue multiple SCSI media data-out commands to transfer the write media-level data. The connection SCSI state machine preferably recognizes the media data-out command, updates the state machine state, and directs the appropriate compression and encryption of the media-level data provided. Each SCSI media data-out command, rewritten with the processed media-level data and proxy information, is then sent to the external named iSCSI target. The last SCSI media data-out command contains an end of data marker, which prompts the return of a SCSI command status response. Upon receipt, the assigned crypto processor 72_{1-N} again updates the connection state machine and returns, subject to proxy rewriting, the SCSI command status response to the external iSCSI initiator.

As indicated by the flow 252 of FIG. 18, other SCSI commands and command status responses, passed within iSCSI data packets, are essentially passed through the connection assigned crypto processor 72_{1-N}, subject to authorization under the transport policy rules and, if transport is permitted, proxy rewriting. The connection state machine is updated with each SCSI command passed in order to remain synchronized to the SCSI state of the external SCSI initiator and target.

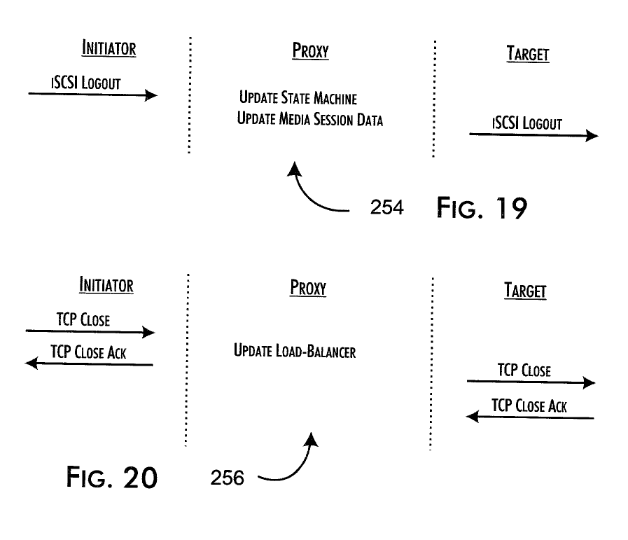

FIGS. 19 and 20 show the preferred process flows for closing an iSCSI connection 254 and closing a TCP connection 256. The closing of an iSCSI connection 254 is performed by the external iSCSI initiator for each TCP connection within a media session in order to close the media session. An iSCSI data packet containing an iSCSI logout command is issued on each TCP connection to the network media access controller 60. Each connection assigned crypto processor 72_{1-N} effectively resets the connection SCSI state machine and updates the media session data. The iSCSI data packet, subject to proxy rewriting, is then sent to the external named iSCSI target.

When the media session for a particular TCP connection has been closed, the underlying TCP connection can be closed by the external iSCSI initiator by issuing a TCP close data packet. The initiator interface processor 66 responds to the TCP close data packet by returning an acknowledgment data packet, updating the connection allocation table maintained by the load-balancer algorithm, and causing the target interface processor 70 to close the corresponding TCP connection with the external named iSCSI target.

Thus, a network media access controller and methods for managing and configuring secure access to external network-attached storage devices has been described. While the present invention has been described particularly with reference to the iSCSI and SCSI protocols, the present invention is equally applicable to providing secure management and configuration for storage devices using any network protocol hosted I/O data transfer protocols.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A scalable media access portal providing connectivity to network attached data storage, said scalable media access portal comprising:
a) a first network interface processor coupleable to a first network;
b) a second network interface processor coupleable to second network;
c) an array of media access processors including an assigned media access processor operative to terminate a first network media access connection relative to said first network and provides a second network media access connection relative to said second network as a proxy for said first network media access connection; and
d) a switch providing data paths between said first and second network interface processors and said array of media access processors, wherein said first network interface processor is operative to selectively route network data associated with said first network media access connection from said first network to said assigned media access processor.

2. The scalable media access portal of claim 1 wherein said first network media access connection is a state-full connection, wherein said assigned media access processor maintains state-data reflective of the dynamic state of said first network media access connection, and wherein said assigned media access processor is responsive to said state-data in maintaining said second network media access connection.

3. The scalable media access portal of claim 2 wherein assigned media access processor implements a transaction protocol state-machine to maintain said second network media access connection in a predetermined correspondence with said first network media access connection.

4. The scalable media access portal of claim 3 wherein the network data selectively routed by said first network interface processor include network media data packets containing information specific to the transport of media-level data and wherein said assigned media access processor inspects network media data packets to obtain said state-data.

5. The scalable media access portal of claim 4 further comprising a shared state-data store accessible by said array of media access processors, wherein said array of media access processors selectively update said shared state-data store, and wherein said assigned media access processor is responsive to said state-data accessed from said shared state-data store in maintaining said second network media access connection.

6. The scalable media access portal of claim 1 wherein network data associated with said first and second network media access connection includes network data packets encapsulating media-level data and wherein said assigned media access processor provides for the encryption of media-level data within network data packets.

7. The scalable media access portal of claim 6 wherein said assigned media access processor provides for the proxy transfer of first network data packets from said first network media access connection to said second network media access connection as second network data packets, said assigned media access processor providing for the selective encryption of media-level data within said second network data packets based on the proxy determined destination of said second network data packets.

8. The scalable media access portal of claim 7 wherein said assigned media access processor provides for the proxy transfer of second network data packets from said second network media access connection to said first network media access connection as said first network data packets, said assigned media access processor providing for the selective decryption of media-level data from said second predetermined network data packets.

9. The scalable media access portal of claim 8 wherein said assigned media processor maintains coordinated the state of said first and second network media access connections to manage the proxy transfer of first and second network data packets between said first and second networks.

10. The scalable media access portal of claim 9 wherein said first and second network data packets include media data transport state information and wherein said assigned media processor is responsive to said media data transport state information to maintain the coordination of said first and second network media access connections.

11. A secure storage access portal provided in a network between client systems and network attached data storage, said secure storage access portal comprising:
a) a data packet processor, including an encryption engine, operative to selectively encrypt a media data portion of network data packets provided to said data packet processor; and
b) a network interface processor coupleable to a client network and a storage network and coupled to said data packet processor to transfer network data packets, said network interface processor operative to associate a persistent network data route between said client and storage networks through said data packet processor such that network data packets associated with said persistent network data route are selectively passed to and from said data packet processor by said network interface processor.

12. The secure storage access portal of claim 11 further comprising a data packet processor array that includes said data packet processor, wherein said network interface processor is operative to selectively associate a plurality of persistent network data routes with said data packet processor.

13. The secure storage access portal of claim 12 wherein said plurality of persistent network data routes are uniquely associated with said data packet processor within said data packet processor array.

14. The secure storage access portal of claim 11 wherein said data packet processor is responsive to a header portion of a predetermined network data packet to select an encryption key for use in encrypting said media data portion of said predetermined network data packet.

15. The secure storage access portal of claim 14 wherein said data packet processor is responsive to an identification of a data storage resource provided by said predetermined network data packet to select said encryption key.

16. A secure storage access portal providing for the routing of data transfer requests and responses between network clients and storage servers, said network media access controller comprising:
a) first network interface processor coupleable to a client network;
b) second network interface processor coupleable to a data storage network;
c) a plurality of data packet processors coupled to said first and second network interface processors, wherein each said data packet processor is operative to terminate respective client network connections routed to said plurality of data packet processors through said first network interface processor and to establish respective storage network connections through said second network interface processor, wherein each said data packet processor provides for the proxy transport of data transfer requests and responses between said client and storage network connections, and wherein each said data packet processor includes an encryption engine operative to selectively encrypt media-level data contained within data transfer requests and responses as transported from said client network connections to said storage network connections.

17. The secure storage access portal of claim 16 further comprising a data switch provided to separately connect said first and second network interface processors with said plurality of data packet processors.

18. The secure storage access portal of claim 17 further comprising a data store accessible by said plurality of data packet processors.

19. The secure storage access portal of claim 18 wherein predetermined client network connections are associated as a connection session, wherein instances of said predetermined client network connections are terminated respectively by first and second data packet processors, wherein said first data packet processor is operative to provide session connection data to said data store and said second data packet processor is operative to retrieve session connection data from said data store.

20. The secure storage access portal of claim 19 wherein said first and second network interface processors are responsive to network data packets received from said client and storage networks, said first and second network interface processors being operative to associate network data packets with said client and storage network connections and correspondingly route network data packets to the respective said data packet processors associated with said client and storage network connections.

21. The secure storage access portal of claim 20 further comprising a control processor coupled through said data switch to said first and second network interface processors and said plurality of data packet processors, said data store being coupled to and accessible by said plurality of data packet processors through said control processor.

22. A method of providing secure storage of media-level data as transported over a network within network data packets that encapsulate data storage packets, wherein data storage packets include storage commands, said method comprising the steps of:
a) establishing a network connection route for network data packets provided from a first network through a network data packet processor to a second network;
b) first processing a network data packet provided through said network connection route to determine a storage command contained within said network storage packet;
c) second processing said network data packet to determine a storage target resource from a data storage packet encapsulated by said network data packet; and
d) filtering, selectively based on a determined correspondence between said storage command and said storage target resource, the transport of said network data packet from said network connection route.

23. The method of claim 22 further comprising the steps of:
a) locating within said data storage packet, selectively based on said storage command, media-level data; and
b) encrypting, selectively based on said storage target resource, the media-level data.

24. The method of claim 23, prior to the step of encrypting, further comprising the step of compressing the media-level data, selectively based on said storage target resource.

25. The method of claim 24 wherein said second processing step includes the step of redirecting said network data packet from said storage target resource to an alternate storage target resource.

26. The method of claim 22 wherein said network data packet processor is one of a plurality of network data packet processors, wherein said step of establishing includes establishing respective network connection routes through said plurality of network data packet processors.

27. The method of claim 26 wherein said respective network connection routes are persistently established through said plurality of network data packet processors.

28. The method of claim 27 further comprising the step of third processing said network data packet to determine the selection of said network connection route from said respective network connection routes.

29. The method of claim 28 further comprising the steps of:
a) locating within said data storage packet, selectively based on said storage command, media-level data; and
b) encrypting, selectively based on said storage target resource, the media-level data.

30. The method of claim 29, prior to the step of encrypting, further comprising the step of compressing the media-level data, selectively based on said storage target resource.

31. The method of claim 30 wherein said second processing step includes the step of redirecting said network data packet from said storage target resource to an alternate storage target resource.
